(19) United States
(12) Patent Application Publication
(10) Pub. No.: US 2010/0017819 A1
(43) Pub. Date: Jan. 21, 2010

(54) Providing Targeted Multimedia Content

(75) Inventors: Myles Gerbrandt, Winnipeg (CA); David Baker, Winnipeg (CA); Patrick Hanan, Winnipeg (CA)

Correspondence Address: NIKOLAI & MERSEREAU, P.A., 900 SECOND AVENUE SOUTH, SUITE 820, MINNEAPOLIS, MN, 55402, US

(73) Assignee: Mars Hill Virtual Management, Inc., Winnipeg (CA)

(21) Appl. No.: 12/503,118

(22) Filed: Jul. 15, 2009

Related U.S. Application Data
(60) Provisional application No. 61/082,046, filed on Jul. 18, 2008.

(51) Int. Cl. H04N 7/025; G06F 17/30; G06F 15/16

(52) U.S. Cl. 725/34; 707/104.1; 707/E17.009; 707/102; 707/E17.044; 709/203

(57) ABSTRACT

Targeted multimedia content stored on a computer system is selected and streamed to users on the network based on requests containing information about the user. A sequence of selected clips is streamed in the order in which they are to be rendered by the user's computing device and delivery of a second clip begins before delivery of the first clip ends, so there is substantially no gap in time between the end of the first clip and the beginning of the second clip from the user's perspective.

### CROSS-REFERENCED TO RELATED APPLICATIONS

This application claims priority based on Provisional Application No. 61/082,046, filed Jul. 18, 2008.

### STATEMENT REGARDING FEDERALLY SPONSORED RESEARCH OR DEVELOPMENT

Not applicable.

### BACKGROUND OF THE INVENTION

### I. Field of the Invention

Various web sites that provide content using the Internet provide multimedia content, such as audio-video content. This content can be provided for marketing, training, and other purposes. However, the content is often impersonal or too generic to be completely useful.

### BRIEF DESCRIPTION OF THE DRAWINGS

FIG. 1 is a block diagram illustrating components employed by the system in various embodiments.

FIGS. 2-4 are flow diagrams illustrating routines employed by the system in various embodiments.

FIG. 5 is a table diagram illustrating tables employed by the system in various embodiments.

FIG. 6 is a block diagram illustrating intelligent streaming performed by the system in various embodiments.

FIGS. 7-8 are flow diagrams illustrating routines employed by the system in various embodiments.

### DETAILED DESCRIPTION

Systems and methods (“the system”) are described for providing targeted multimedia content. In various embodiments, the system extends existing web sites. A web site operator can provide to the system one or more uniform resource locaters (URLs). When receiving a request, the system can provide customized or targeted multimedia (e.g., audiovisual) content. As an example, the system can receive information about a user, such as the user's name, title, occupation or industry, and so forth, and can assemble audiovisual clips that provide content that is targeted to the user. In various embodiments, the system can provide intelligent streaming of audiovisual content by queuing a sequence of clips so that a subsequent clip is streamed before a prior clip ends so that the user does not experience delays between clips.

Several embodiments of the facility are described in more detail in reference to the figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

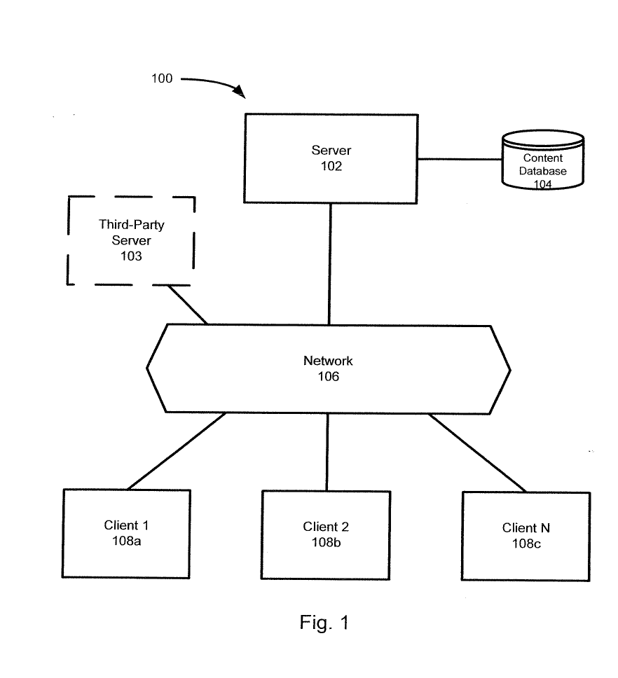

FIG. 1 is a block diagram illustrating components employed by the system in various embodiments. The system 100 includes a server computing device 102 that is connected to a content storage or database 104. The content database 104 can store content, such as multimedia content, that the server computing device 102 can employ when providing targeted content. The server 102 may handle requests, such as hypertext transfer protocol (“HTTP”) requests from client computing devices, for content. The server may then provide the requested content via a network 106, such as the Internet, to one or more client computing devices, such as client computing devices 108a, 108b, and 108c. Users may employ the client computing devices to request targeted content from the server 102 or provide content that the server 102 can store in the content database 104. The system can also optionally include a third-party server 103. The third-party server may receive HTTP requests from a user's web browser and may employ services provided by server 102 to provide content, such as multimedia content. In various embodiments, the third-party server may have a folder associated with its domain whose contents are provided by server 102.

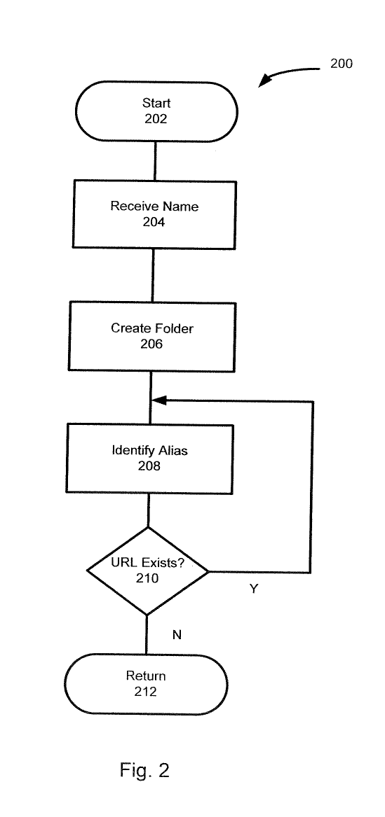

FIGS. 2-4 are flow diagrams illustrating routines employed by the system in various embodiments.

FIG. 2 is a flow diagram illustrating a routine 200 that the system can invoke in various embodiments to uniquely create and track folders. The routine begins at block 202. At block 204, the routine receives a name for a folder. At block 206, the routine creates the folder. The folder can be used to identify and/or store multimedia content. At block 208, the routine identifies an alias for the storage. The routine may employ logic to uniquely identify the alias. If the storage should be named John Smith, but a uniform resource locator (“URL”) already exists for that name, the routine may add various text to uniquely identify the URL. As examples, the routine may add underscore or other characters between whitespaces, add a numerical suffix, and so forth to avoid duplicates. The system may use unique URLs to track accesses to content. At decision block 210, the routine determines whether a URL for the alias already exists. If the URL already exists, the routine continues at block 208 where it identifies a different alias. Otherwise, the routine returns at block 212.

Those skilled in the art will appreciate that the logic illustrated in FIG. 2 and described above, and in each of the flow diagrams discussed below, may be altered in a variety of ways. For example, the order of the logic may be rearranged, substeps may be performed in parallel, illustrated logic may be omitted, other logic may be included, etc.

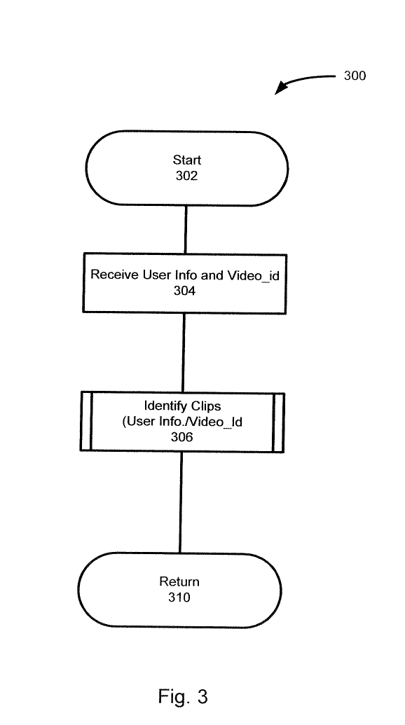

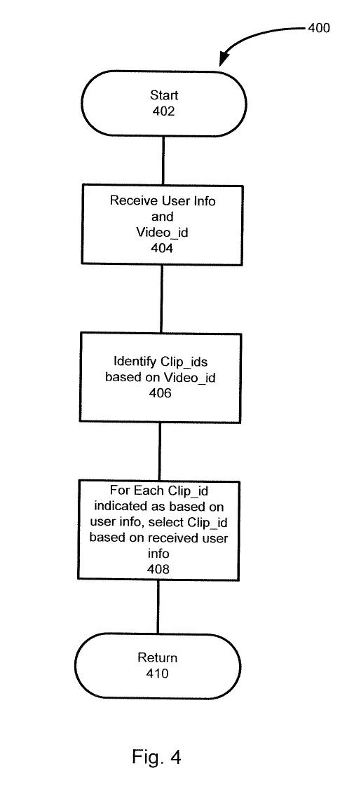

FIG. 3 is a flow diagram illustrating a routine 300 that the system can invoke in various embodiments to assemble clips, such as multimedia clips. The routine begins at block 302. At block 304, the routine receives information about the user and a video identifier (“video_ID”). As examples, the routine may receive the user's name, title, occupation, employer, industry of employment, and/or so forth. The video_ID can be determined from the URL that the request indicates. At block 306, the routine invokes an identify_clips subroutine to identify a sequence of clips that the system should provide to satisfy the request. The identify_clips subroutine is described in further detail below in relation to FIG. 4. The routine may provide the received user information and video_ID to the identify_clips subroutine. At block 308, the routine provides a list of clips that the identify_clips subroutine provides. At block 310, the routine returns.

FIG. 4 is a flow diagram illustrating an identify_clips subroutine 400 that the system can invoke in various embodiments. The subroutine begins at block 402. At block 404, the subroutine receives user information and a video_ID. At block 406, the routine identifies a clip identifier based on the received video_ID. Each multimedia clip may have a unique identifier. At block 408, for each identified clip identifier that is indicated as being based on user information, the subroutine selects a clip identifier based on the received user information. As an example, if a clip is based on the user's name, the subroutine may select a multimedia clip that speaks the user's name. Thus, multimedia content can be provided that addresses the user by his or her first name. In various embodiments, the system may consider the user's first name and/or last name. At block 410, the routine returns.

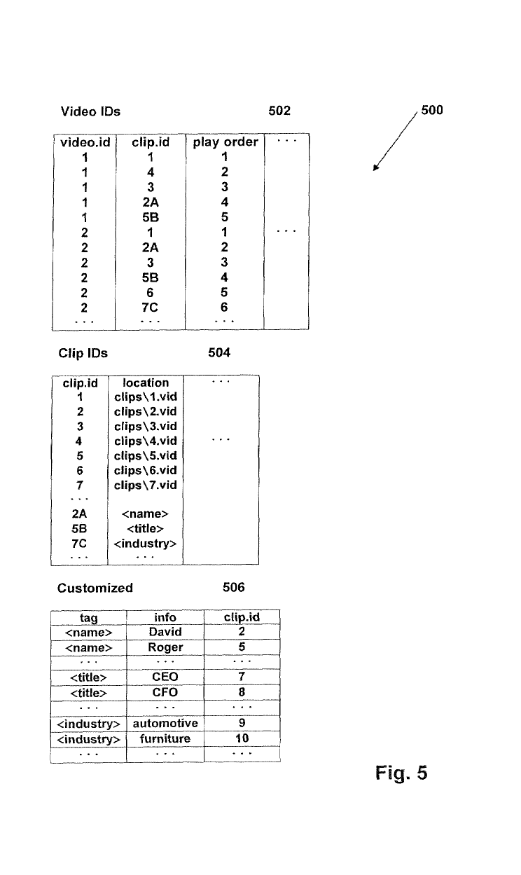

FIG. 5 is a table diagram illustrating tables employed by the system in various embodiments. The system can employ multiple tables 500.

Table 502 can describe relationships between video identifiers, clip identifiers, and the order in which the clips should be provided, streamed, or otherwise rendered. For example, the table can include video_ID, clip_ID, and play_order columns. Each video_ID can be associated with one or more clip_IDs. Each associated clip_ID has a sequence number. In the illustrated example, video_ID “1” is associated with clip_IDs 1, 2A, 3, 4, and 5B. They are to be rendered in the following order: 1, 4, 3, 2A, and 5B when video_ID “1” is requested.

Table 504 can identify locations at which each clip is stored, such as in the content database 104 illustrated above in relation to FIG. 1. In the illustrated example, clip 1 is stored at the location clips\1.vid. Clip 2A depends on the user's name. Clip 5B depends on the user's title. Clip 7C depends on the user's industry.

Table 506 can identify targeting or customization relationships. In the illustrated example, if the user's name is “David,” clip_ID 2 is rendered. If the user's name is “Roger,” clip_ID 5 is rendered. In some embodiments, the clips can be named based on the content and stored in separate folders. For example, a clip named “David” can be stored in a “name” folder so that content can be quickly identified for information provided by the user. If the user's title is CEO, clip 7 is rendered. If the user's title is CFO, clip 8 is rendered. A video can contain zero or more customized clips. For example, video_ID 1 has customized clips for name (2A) and title (5B). Thus, a video clip can address the user by name and provide content specific to his or her job function. If no clip is available to provide customized content, the system can provide generic content.

While FIG. 5 illustrates tables whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc. In some embodiments, a video clip may indicate a next video clip that is to be rendered, thereby obviating the need for one or more of the illustrated tables.

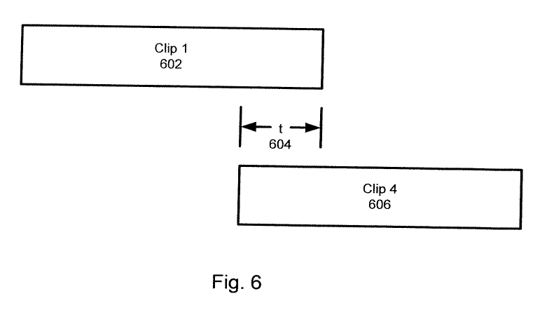

FIG. 6 is a block diagram illustrating intelligent streaming performed by the system in various embodiments. Multimedia content is sometimes streamed to clients. Various streaming technologies exist. For example, video streaming can be performed using MACROMEDIA FLASH. When a clip is streamed, the client buffers an initial portion before beginning playback so that the playback can progress smoothly without interruptions. Multiple clips can be sequenced to form a longer presentation. However, the client may then buffer each clip separately. Thus, when a first clip ends, the client may begin buffering a second clip. Thus, the user would perceive a gap between the two clips. The system can avoid such gaps by beginning streaming of a second clip before a first clip ends. To avoid buffering several clips simultaneously and thereby placing increased load on both the client and the server, the system begins buffering a second clip a specified time duration (e.g., one second) before a first clip ends. In the illustrated example, the video 600 includes clips 602 and 606. The system begins buffering clip 606 a specified time duration “t” 604 before clip 602 will end. Because the client already has buffered clip 606, it can continue playback of the video 600 without a gap after clip 602 ends.

The system can track various information, such as how many times a particular URL or video is viewed, whether videos are viewed in their entirety or a shorter duration, times/dates videos are viewed, whether the user clicked on a link to receive additional information, and so forth.

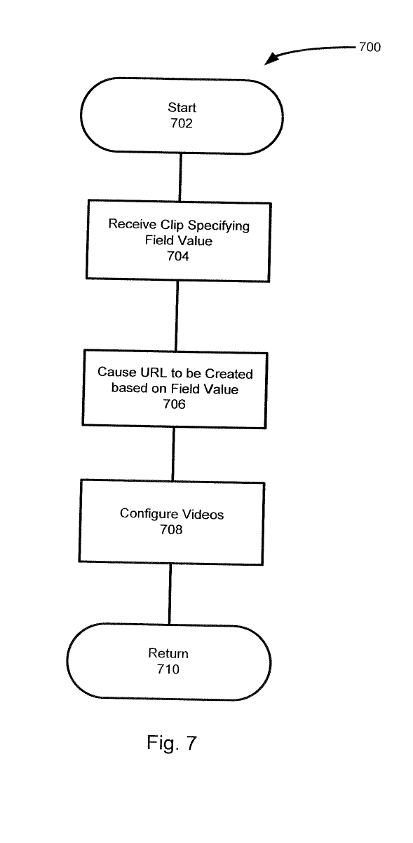

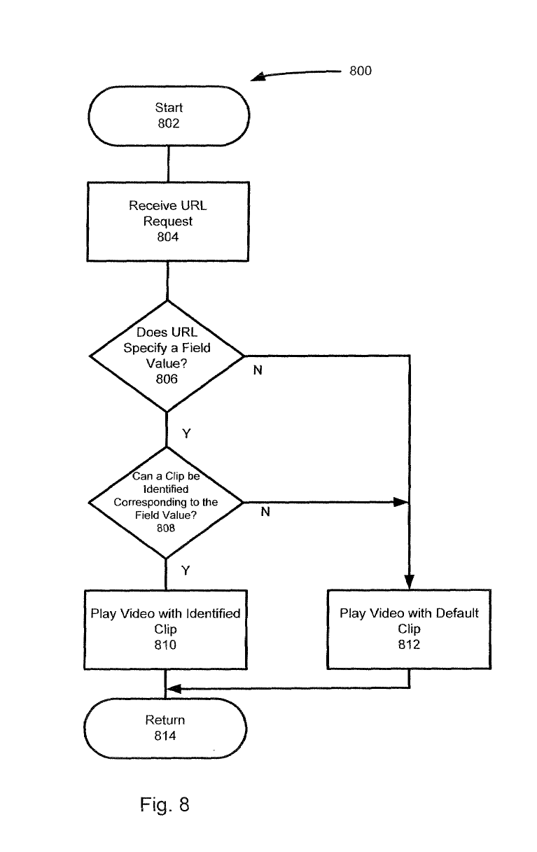

FIGS. 7-8 are flow diagrams illustrating routines employed by the system in various embodiments.

FIG. 7 is a flow diagram illustrating a routine the system can employ to create a URL, such as when receiving a multimedia file (e.g., a video). The routine 700 begins at block 702. At block 704, the routine receives a video clip (or other multimedia clip). The system may also receive a field value. The system can receive the field value as a property of the video clip or may receive the field value separately. As an example, the system may receive a video clip that says “David” and a field value with the text “David.” At block 706, the system causes the URL to be created based on the received field value. The URL may be created on the same server that serves the video clip or another server. As an example, the system may function with a third party that provides a web site and the system can direct the third-party web server to create a URL with the field value. As an example, the third party may create a URL with its domain name and “/<field-value” as a folder (where “<field-value>” is the received field value (e.g., “David”). At block 708, the system can configure one or more videos so that the received video clip can be employed. As an example, the system may modify the tables illustrated in FIG. 5 so that the video clip is available to be rendered. The system returns at block 710.

In the above, although embodiments are described in reference to “videos,” the system can function with any sort of multimedia elements, clips, or other storage formats.

FIG. 8 is a flow diagram illustrating a routine the system can invoke to provide content relating to a requested URL. As an example, a user can navigate a web browser to a third-party server and a folder “/David.” The web server that hosts the URL can determine that it does not have content associated with the folder and may request the system to provide the relevant content. The system can invoke routine 800. The routine begins at block 802. At block 804, the system receives a URL request. At decision block 806, the system may determine whether the URL specifies a field value. Some URLs may specify field values (e.g., names, titles, etc.), but others may simply be other URLs. If the URL specifies a field value, the system continues at decision block 808. Otherwise, the system continues at block 812. At decision block 808, the system determines whether a clip can be identified that corresponds to the specified field value. If so, the system continues at block 810. Otherwise, the system continues at block 812. At block 810, the system plays the video corresponding to the identified clip. As an example, the system may select for rendering a video that contains an entry for a customized video clip. At block 812, the system plays a video that does not contain a customized video clip. The system returns at block 814.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

What is claimed is:

1. An apparatus for providing targeted media content to users on a network comprising a storage device containing a database of multimedia content, a server coupled to said storage device and to a network, and a plurality of client computing devices which communicate with the server via the network, wherein:
a. said database contains a plurality clips associated with a unique identifier for each clip and information identifying the nature of the content of each clip;
b. said server (i) receives a request for video content from at least one of said plurality of client computing devices, the request containing information about the user of the client computing device used to make the request and a video identifier; (ii) identifies clips satisfying the request using the video identifier and matching information about the user contained in the request to the information identifying the nature of the content of each of the clips; (iii) creates a sequence of clips from the identified clips; and (iv) delivers the sequence of clips to the client computing device in the order in which they are to be rendered by the client computing device and, when the sequence of clips contains a plurality of clips, begins delivering a second clip before delivery of a first clip ends; and
c. the client computing device begins rendering the sequence of clips before it has received all of the clips in the sequence.

2. The apparatus of claim 1 wherein the server begins delivering the second clip a specified duration of time before delivery of the first clip ends.

3. The apparatus of claim 1 wherein there is substantially no gap in time between the end of the first clip and the beginning of the second clip as they are rendered by the client computing device.

4. The apparatus of claim 1 wherein when an additional clip is added to the database, the server (i) receives the clip being added, a proposed identifier for the clip being added and information identifying the nature of the content of the clip being added; (ii) checks to see if the identifier for the clip being added uniquely identifies the clip and, if not, assigns a unique identifier to the clip being added; and (iii) stores in the database the clip being added, the unique identifier assigned to the clip being added, and the information identifying the nature of the content of the clip being added in a fashion that associates the clip being added with the unique identifier for the clip being added and the information identifying the nature of the content of the clip being added.

5. A method of providing targeted media content to users of client computing devices comprising:
a. creating a database containing a plurality clips, a unique identifier for each clip and for each clip information identifying the nature of the content of the clip;
b. receiving on a server from a client computing device a request for video content, the request containing information about the user of the client computing device and a video identifier;
c. using the video identifier and matching the information about the user contained in the request to the information identifying the nature of the content of each of the clips contained in the database to identify clips satisfying the request;
d. creating a sequence of clips from the identified clips;
e. delivering the sequence of clips to the client computing device in the order in which they are to be rendered by the client computing device such that when the sequence of clips contains a plurality of clips, delivery of a second clip begins before delivery of a first clip ends; and
f. initiating rendering the sequence of clips on the client computing device before the client computing device has received all of the clips in the sequence.

6. The method of claim 5 wherein the server begins delivering the second clip a specified duration of time before delivery of the first clip ends.

7. The method of claim 5 wherein there is substantially no gap in time between the end of the first clip and the beginning of the second clip as they are rendered by the client computing device.

8. The method of claim 5 wherein when an additional clip is added to the database, the server (i) receives the clip being added, a proposed identifier for the clip being added and information identifying the nature of the content of the clip being added; (ii) checks to see if the identifier for the clip being added uniquely identifies the clip and, if not, assigns a unique identifier to the clip being added; and (iii) stores in the database the clip being added, the unique identifier assigned to the clip being added, and the information identifying the nature of the content of the clip being added in a fashion that associates the clip being added with the unique identifier for the clip being added and the information identifying the nature of the content of the clip being added.
